(19) United States
(12) Patent Application Publication
(10) Pub. No.: US 2017/0101813 A1
(43) Pub. Date: Apr. 13, 2017

(54) AUTOMATED CLOSING DEVICE FOR SLIDING SCREEN DOOR PANEL

(71) Applicant: Ron Crowder, II, Rowland Heights, CA (US)

(72) Inventor: Ron Crowder, II, Rowland Heights, CA (US)

(21) Appl. No.: 14/877,581

(22) Filed: Oct. 7, 2015

(51) Int. Cl. E05F 1/16; E05F 3/18

(52) U.S. Cl. CPC E05F 1/16; E05F 3/18

(57) ABSTRACT

A device that has adjustable torque, and is used for the mechanical automation of closing a sliding screen door panel in a manner that is consistent with the force of a natural beings manual operation of the sliding screen door panel. The device is engineered to be consistent with the design of the said sliding screen panel, to prevent failure of the sliding screen panel after longterm continuous use with the device.

### FIELD OF THE INVENTION

The automation of closing an opening, in particular the closing of a sliding screen door panel.

### BACKGROUND OF THE INVENTION

Related screen door closing devices are abundant in prior art. Past art indicates devices that are complicated in nature including but not limited to the way it is attached, location of device on or around said opening, mechanism for automation, and the amount of components essential to function properly within the device.

In U.S. Pat. No. 5,937,478 a torsion spring is used to operate the device, though the torsion springs rigidness does not allow for a wide range of torque, and may or may not close the screen door panel successfully. Range of torque is addressed in U.S. Pat. No. 5,659,999, though the range of torsion is adjustable, the amount of components used for the device to function properly is not ideal for the manufacturing process and cost efficiency.

Some devices require a permanent structure to attach to, in a permanent manner, as seen in U.S. Pat. No. 5,630,249 making installation difficult or impossible if no other structure exists to attach the device to, as in door location being on the corner of a structure. Other devices installation locations are not ideal, causing an unbalanced distribution of force on the sliding screen door panel, this could subsequently result in the failure of the said sliding screen door panel.

### SUMMARY OF THE INVENTION

Automating the closing of a sliding screen door in a manner that is consistent with the force of a natural beings manual operation of the sliding screen door panel, and consequently consistent with the design of the sliding screen door panel, to prevent failure of said panel after continuous, non-abusive, operation of said panel.

The attachment of the device will be straight forward and uncomplicated in nature, or design. An adhesive, double sided mounting tape with a weight capacity consistent with its use, will secure the device to the sash edge of the anchored glass panel. This location is between and parallel to the sliding glass panel and sliding screen panel, approximately centered, and horizontally in line with the manual operating handle of the sliding screen panel. The support will also be attached with same type of adhesive, double sided mounting tape, to the trailing frame of the sliding screen panel, horizontally in line with the manual operating handle of the sliding screen panel. The support and device will be joined by way of polly braid and clasp. At one end, the polly braid is permanently attached to the devices internal mechanism, in particular the cylinder. At the other end the poly braid is permanently attached to the closed end of the clasp, the open end of the clasp is attached to the support.

When the device is installed, the screen panel being in a closed position the poly braid will be spooled around the cylinder under a preset pressure from the torqued spring. When the sliding screen panel is opened manually the attached support pulls the clasp, and subsequently the spooled poly braid, which causes the cylinder to move in a circular direction around its axis, in this case the axis being the dowel. The dowel torques the spiral torsion spring further than the preset torque causing a graduating pressure on the dowel, cylinder, poly braid, clasp, support, and screen panel sash. Once the manual pressure is no longer present the screen panel closes in an automated manner due to the graduating pressure, or force of the torqued spiral torsion spring attached to the dowel, cylinder, poly braid, clasp, support, and sliding screen panel.

The device is adjustable and can be set to different torque settings in a non complicated way. These torque settings are accomplished by applying manual pressure in an upward and twisting motion on the dial at the bottom of the device. When applying upward manual pressure, the compression cap, located at the top of the cylinder, will compress against the top of the housing, causing the dial and subsequently the dial tabs to move upward and out of there tab slots. When twisting the dial, torque will increase or decrease depending on the direction you twist the dial. Once the desired torque is achieved stop applying the upward pressure but continue to hold the dial in the position of the desired torque, twist slightly in either direction until the dial tabs align and set back into the tab slots.

The device can also be completely disengaged without uninstalling, so that the door can be quickly operated manually, in its original state. This can be accomplished by simply uncoupling the open end of the clasp from the support.

### BRIEF DESCRIPTION OF THE DRAWINGS

FIG. 1, is the device installed on the sash edge of the anchored glass panel.

FIG. 2, is the device in its entirety, uninstalled.

FIG. 3, is the device without upper brace, lower brace or clasp support.

FIG. 4, is the lower portion of the device with a top view of the detached dial.

FIG. 5, is the device partially disassembled exposing the cylinder.

FIG. 6, is the device disassembled further , exposing the spiral torsion spring assembly.

### DETAILED DESCRIPTION OF INVENTION

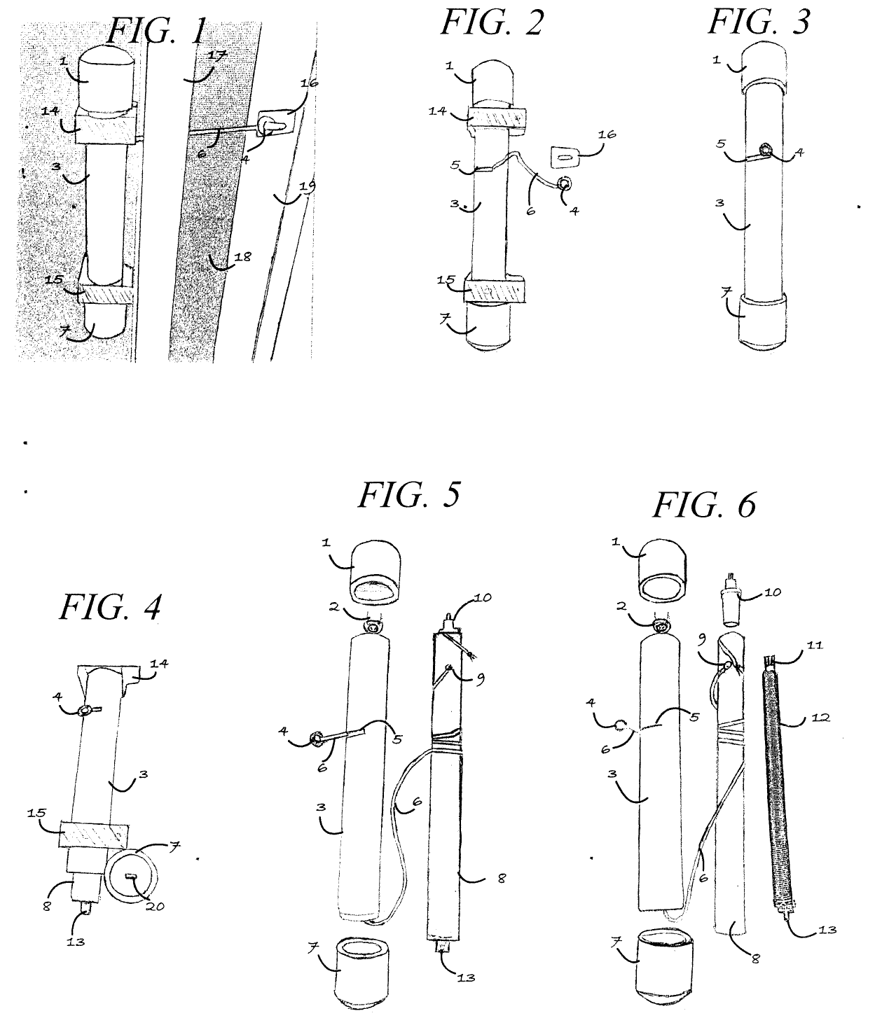

With reference to FIG. 1-6 the device designated by the number 100 attached to the anchored glass panel sash edge 17 by way of upper brace 14 and lower brace 15. When the sliding screen panel 18 is manual operated towards the open position, the sliding screen panel frame 19 moves the attached support 16 consequently pulling the clasp 4 that is attached to polly braid 6. The polly braid 6 is permanently attached to the cylinder 8 through the orifice 9, and leaves the device 100 through the cover slit 5 causing the cylinder 8 to rotate within the cover 3. When the cylinder 8 rotates, it causes the spiral torsion spring 12 to torque, creating tension on the polly braid 6 and subsequently the sliding screen panel frame 19, causing the sliding screen panel 18 to close when the manual operation pressure is no longer present.

The spiral torsion spring 12 within the cover 3 is permanently affixed to the Dowel 11 at one end and permanently affixed to the cylinder 8 at the other end. The key 13 is permanently affixed to the end of the dowel 11 and fits tightly inside the dial lock 20, located at the bottom of the dial 7. The device 100 can be adjusted to apply more or less tension. Torque settings are accomplished by applying manual pressure in an upward and twisting motion on the dial 7 at the bottom of the device. When applying upward manual pressure, the compression cap 10, located at the top of the cylinder 8, will compress against the spacer 2 permanently affixed to the top of the housing 1, causing the dial 7 and subsequently the dial tabs 22 to move upward and out of the tab slots 21. When rotating the dial 7, torque will increase or decrease depending on the direction rotated.

What is claimed is:

1. A device to automate the closing of a sliding screen door panel comprised of:
(a) a support to attach a clasp to a sliding screen panel;
(b) a clasp attached to a poly braid;
(c) a poly braid attached to a cylinder;
(d) a cover;
(e) a brace to attach the device to a sash;
(f) an opening in the cover to allow the poly braid ingress and egress;
(g) a cylinder within the housing to hold the spooled poly braid;
(h) a spiral torsion spring within the cylinder;
(i) a compression cap apexed to the cylinder;
(j) a spacer affixed to a housing;
(k) a dowel within and attached to a spiral torsion spring;
(l) a key attached to the end of the dowel;
(m) a dial lock to accommodate the key
(n) a dial to adjust tension;
(o) dial tabs and tab slots to hold the dials position under tension.
